(19) United States
(12) Patent Application Publication
(10) Pub. No.: US 2021/0148222 A1
(43) Pub. Date: May 20, 2021

(54) SHORT-RANGE TELEMETRY SYSTEM

(71) Applicant: APS Technology, Inc., Wallingford, CT (US)

(72) Inventors: John DWYER, Stratford, CT (US); Kris PARSONS, Plainville, CT (US); Thomas Yung YOON, West Kelowna (CA)

(73) Assignee: APS Technology, Inc., Wallingford, CT (US)

(21) Appl. No.: 16/690,055

(22) Filed: Nov. 20, 2019

(51) Int. Cl. E21B 47/12

(52) U.S. Cl. CPC E21B 47/122; E21B 47/024

(57) ABSTRACT

A system configured to operate along a bottom hole assembly of a drill string in a downhole drilling environment includes a short-range telemetry sub having at least one receiving antenna and at least one transmitting antenna. The system also includes a computing device coupled to the at least one receiving antenna and the at least one transmitting antenna. The computing device is configured to, in response to receiving a signal, filter the received signal to generate a filtered signal, convert the filtered signal to a digital signal; and process the digital signal to reduce signal noise.

### TECHNICAL FIELD

The present disclosure relates to a system, tool, and method for short-range telemetry in a downhole drilling environment.

### BACKGROUND

Underground drilling, such as gas, oil, or geothermal drilling, generally involves drilling a bore through a formation deep in the earth. Such bores are formed by connecting a drill bit to long sections of pipe, referred to as a “drill pipe,” to form an assembly commonly referred to as a “drill string.” Rotation of the drill bit advances the drill string into the earth, thereby forming the bore. Directional drilling refers to drilling systems configured to allow the drilling operator to direct the drill bit in a particular direction to reach a desired target hydrocarbon that is located some distance vertically below the surface location of the drill rig and is also offset some distance horizontally from the surface location of the drill rig. Steerable systems use bent tools located downhole for directional drilling and are designed to direct the drill bit in the direction of the bend. Rotary steerable systems use moveable blades, or arms, that can be directed against the borehole wall as the drill string rotates to cause directional change of the drill bit. Directional drilling systems have been used to allow drilling operators to access hydrocarbons that were previously un-accessible using conventional drilling techniques.

To help maximize drilling efficiency, telemetry is used while drilling to transmit data from sensors located downhole to the surface as a well is drilled. Obtaining and transmitting information is commonly referred to as measurement-while-drilling (“MWD”) and logging-while-drilling (“LWD”). One transmission technique is electromagnetic (“EM”) telemetry. Typical drilling data includes formation characteristics, well path direction and inclination, and other various drilling parameters. In particular, MWD and LWD systems have used EM tools, located downhole and coupled to sensors along the drill string, to create electric and magnetic fields that propagate through the formation in order to convey drilling data to a receiver on the surface.

Another technique for transmitting data between surface and downhole locations is mud pulse telemetry. In a mud pulse telemetry system, signals from the sensor modules are received and encoded in a module housed in a bottom hole assembly. A controller actuates a pulser, also incorporated into the bottom hole assembly, that generates pressure pulses in the drilling fluid flowing through the drill string and out of the drill bit. The pressure pulses contain the encoded information. The pressure pulses travel up the column of drilling fluid to the surface, where they are detected by a pressure transducer. The data from the pressure transducers are then decoded and analyzed as needed.

Another transmission technique is short-range telemetry. In a short-range telemetry system, an antenna is used to create a magnetic, electric, or acoustic field in order to transmit data from sensors close to the drill bit, past one or more downhole tools along the bottom hole assembly. Data is transmitted via the magnetic, electric, or acoustic field and picked up by a receiving antenna located uphole. The data is then transmitted through some form of telemetry, e.g. mud-pulse telemetry, to the surface. The system transmits signals in a single, upward direction across drilling system components and up to a receiver subsystem (“sub”). However, conventional short-range telemetry systems have limits and are not effective in certain conditions. For example, significant noise may by generated when the drill string is rotating too fast or too much mud flow is traveling through the system. Elevated noise levels hinders the ability to detect useable signals.

### SUMMARY

There is a need to provide better short-range telemetry in a drilling environment that transmits and receives data without hampering signals due to noise, in order to improve the signal chain and minimize bit error rate. An embodiment of the present disclosure is a system configured to operate along a bottom hole assembly of a drill string in a downhole drilling environment. The system includes a first short-range telemetry sub having at least one antenna, and a second short-range telemetry sub having at least one antenna. The second short-range telemetry sub is separated from the first short-range telemetry sub by one or more components of the bottom hole assembly. The system further includes a first computing device coupled to the at least one antenna of the first short-range telemetry sub and a second computing device coupled to the at least one antenna of the second short-range telemetry sub. The first computing device and the second computing device are configured to, in response to receiving a signal, filter the received signal to generate a filtered signal, convert the filtered signal to a digital signal, and process the digital signal to reduce signal noise. The first computing device and the second computing device are further configured to demodulate the digital signal and transmit the digital signal to a location uphole or downhole. The first computing device and the second computing device are further configured to access communication information detected by the at least one antenna of the first short-range telemetry sub and the at least one antenna of the second short-range telemetry sub, identify a communication setting based on the communication information, and instruct the at least one transmitting antenna to transmit signals in accordance with the communication setting.

Another embodiment of the present disclosure is a system configured to operate along a bottom hole assembly of a drill string in a downhole drilling environment. The system includes a first short-range telemetry sub having at least one transmitting antenna and at least one receiving antenna. The system further includes a second short-range telemetry sub having at least one transmitting antenna and at least one receiving antenna and separated from the first short-range telemetry sub by one or more components of the bottom hole assembly. The system further includes a first computing device coupled to the at least one transmitting antenna and the at least one receiving antenna of the first short-range telemetry sub. The system further includes a second computing device coupled to the at least one transmitting antenna and the at least one receiving antenna of the second short-range telemetry sub. The first computing device and the second computing device are configured to, in response to receiving a signal, filter the received signal to generate a filtered signal, convert the filtered signal to a digital signal; and process the digital signal to reduce signal noise.

A further embodiment of the present disclosure is a method that includes transmitting a signal via a transmitting antenna carried by a first short-range telemetry sub. The method further includes detecting, via a receiving antenna carried by a second short-range telemetry sub, the signal transmitted by the transmitting antenna. The method further includes filtering the transmitted signal to generate a filtered signal, converting the filtered signal to a digital signal, and processing the digital signal to reduce signal noise. The method further includes demodulating the digital signal via the computing device, and transmitting the digital signal to a location uphole. The method further includes accessing communication information via the computing device, identifying a communication setting based on the communication information via the computing device, and instructing the at least one transmitting antenna to transmit signals and the at least one receiving antenna to receive signals in accordance with the communication setting via the computing device.

Another embodiment of the present disclosure is a short-range telemetry sub for a downhole tool assembly. The short-range telemetry sub includes at least one antenna, and a computing device. The computing device is configured to, in response to receiving a signal, filter the received signal to generate a filtered signal, convert the filtered signal to a digital signal, and process the digital signal to reduce signal noise. The computing device is further configured to demodulate the digital signal, and transmit the digital signal to a location uphole. The computing device is further configured to access communication information detected by the at least one receiving antenna, identify a communication setting based on the communication information, and instruct the at least one transmitting antenna to transmit signals in accordance with the communication setting.

### BRIEF DESCRIPTION OF THE DRAWINGS

The foregoing summary, as well as the following detailed description, will be better understood when read in conjunction with the appended drawings. The drawings show illustrative embodiments of the disclosure. It should be understood, however, that the application is not limited to the precise arrangements and instrumentalities shown.

FIG. 1 is a schematic side view of a drilling system according to an embodiment of the present disclosure;

FIG. 2A is a schematic side view of an exemplary short-range telemetry system;

FIG. 2B is a schematic block diagram illustrating the short-range telemetry system in FIG. 2A;

FIG. 3 is a perspective exploded view of a short-range telemetry system implemented on a drilling tool, according to an embodiment of the present disclosure;

FIG. 4 is a perspective view of an uphole short-range telemetry sub of the short-range telemetry system shown in FIG. 3;

FIG. 5 is a perspective view of a downhole short-range telemetry sub of the short-range telemetry system shown in FIG. 3;

FIG. 6 is a top view of a hatch cover of the short-range telemetry subs shown in FIG. 4 and FIG. 5;

FIG. 7 is a process flow diagram illustrating a method for providing communication between an uphole antenna and a downhole antenna of the short-range telemetry system shown in FIG. 3;

FIG. 8 is a perspective exploded view of a magnetic short-range telemetry system implemented on a drilling tool, according to another embodiment of the present disclosure;

FIG. 9 is a perspective view of an uphole short-range telemetry sub of the short-range telemetry system shown in FIG. 7;

FIG. 10 is a perspective view of a downhole short-range telemetry sub of the short-range telemetry system shown in FIG. 8;

FIG. 11 is a perspective view of a hatch cover of the short-range telemetry subs shown in FIG. 9 and FIG. 10;

FIG. 12 is a process flow diagram illustrating a method for providing communication between a downhole transmitting antenna and uphole receiving antenna and between an uphole transmitting antenna and downhole receiving antenna of the short-range telemetry system shown in FIG. 8; and

FIG. 13 is a block diagram of signal processing components of a short-range telemetry sub according to an embodiment of the present disclosure.

### DETAILED DESCRIPTION OF ILLUSTRATIVE EMBODIMENTS

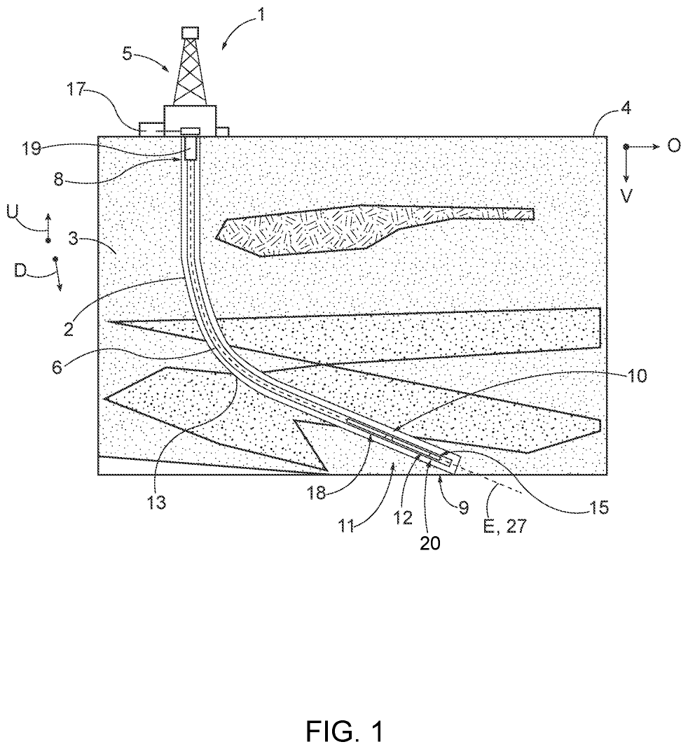

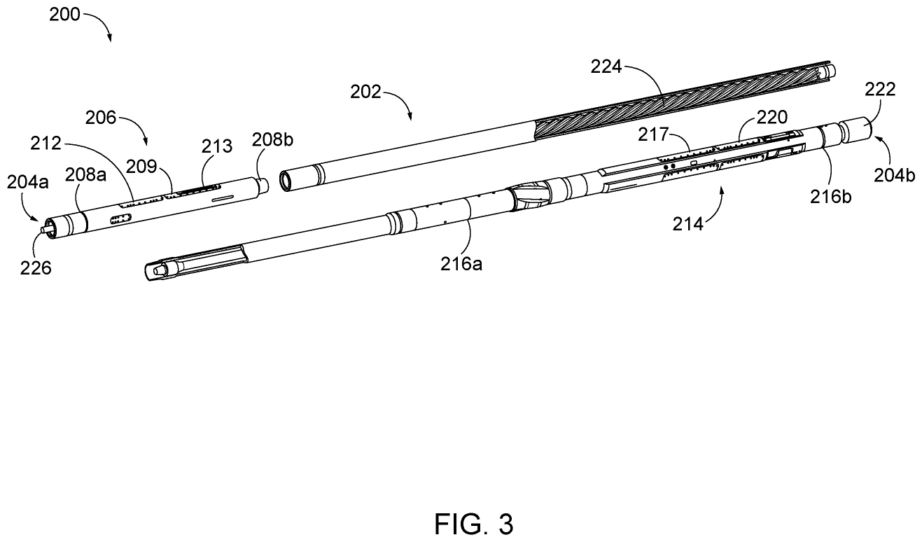

As shown in FIGS. 1 and 3, embodiments of the present disclosure include a short-range telemetry system 200 configured for use in a downhole drilling environment in a drilling system 1. The short-range telemetry system 200 is used to transfer data between locations near a drill bit 15 to locations uphole along a bottom hole assembly (BHA) 10 over relatively short distances, e.g., a distance of up to about 60 feet. However, short-range telemetry transmissions may travel distances that exceed 60 feet. In accordance with the embodiment disclosed in the present disclosure, the short-range telemetry system 200 may obtain data near the drill bit and transmit that data uphole along the BHA 10. The transmitted data may then be transmitted to the surface 4 of an earthen formation 3. In addition, data may be transmitted from an uphole location along the BHA 10 to a location near the drill bit. Thus, the short-range telemetry system 200 may be used for one way or two-way communications, while operating downhole, as further explained below

Referring to FIG. 1, the drilling system 1 includes a rig or derrick 5 that supports a drill string 6. The drill string 6 is elongate along a longitudinal central axis 27 that is aligned with a well axis E. The drill string 6 further includes an uphole end 8 and a downhole end 9 spaced from the uphole end 8 along the longitudinal central axis 27. A downhole or downstream direction D refers to a direction from the surface 4 toward the downhole end 9 of the drill string 6. An uphole or upstream direction U is opposite to the downhole direction D. Thus, “downhole” and “downstream” refers to a location that is closer to the drill string downhole end 9 than the surface 4, relative to a point of reference. “Uphole” and “upstream” refers to a location that is closer to the surface 4 than the drill string downstream end 9, relative to a point of reference.

Continuing with FIG. 1, the drill string 6 includes a bottom hole assembly 10 coupled to the drill bit 15. The drill bit 15 is configured to drill a borehole or well 2 into the earthen formation 3 along a vertical direction V and an offset direction O that is offset from or deviated from the vertical direction V. The drilling system 1 can include a surface motor (not depicted) located at the surface 4 that applies torque to the drill string 6 via a rotary table or top drive (not depicted), and a downhole motor 18 disposed along the drill string 6 that is operably coupled to the drill bit 15 for powering the drill bit 15. Operation of the downhole motor 18 causes the drill bit 15 to rotate along with or without rotation of the drill string 6. In this manner, the drilling system 1 is configured to operate in a rotary drilling mode, where the drill string 6 and the drill bit 15 rotate, or a sliding mode where the drill string 6 does not rotate but the drill bit does rotate. Accordingly, both the surface motor and the downhole motor 18 can operate during the drilling operation to define the well 2. The drilling system 1 can also include a casing 19 that extends from the surface 4 and into the well 2. The casing 19 can be used to stabilize the formation near the surface. One or more blowout preventers can be disposed at the surface 4 at or near the casing 19. During the drilling operation, the drill bit 15 drills a borehole into the earthen formation 3. A pump 17 pumps drilling fluid downhole through an internal passage (not depicted) of the drill string 6 out of the drill bit 15. The drilling fluid then flows upward to the surface through the annular passage 13 between the bore hole and the drill string 6, where, after cleaning, it is recirculated back down the drill string 6 by the mud pump.

As shown in FIG. 1, embodiments of the present disclosure may include a plurality of sensors 20 located along the drill string 6 for sensing a variety of characteristics related to the drilling operation. The sensors 20 can include accelerometers, magnetometers, strain gauges, temperature sensors, pressure sensors, or any other type of sensor as conventionally used in a drilling operation to measure drilling, fluid, and/or formation data, including inclination, tool face angle, azimuth, temperature, pressure, drill string rotational speed, mud motor speed, drill bit acceleration, drill bit temperature, drill string RPM, natural or azimuthal gamma radiation, etc.

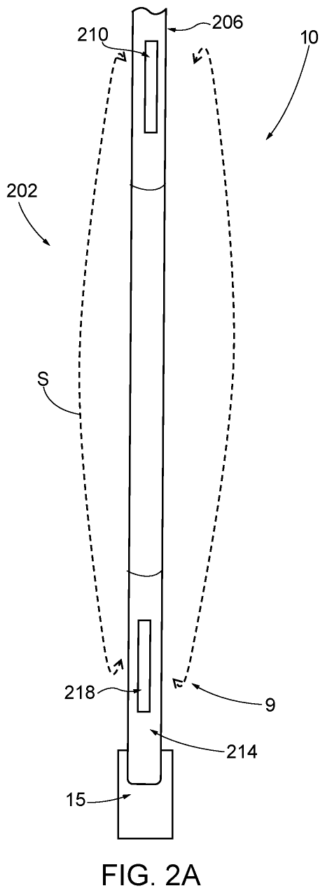

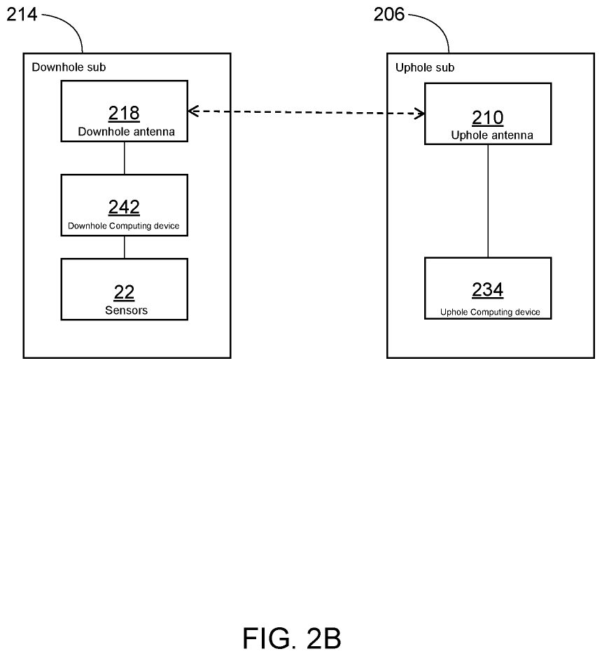

Referring to FIGS. 2A and 2B an exemplary short-range telemetry system 200 includes at least a housing assembly 202 and an uphole telemetry sub 206 having an uphole antenna 210, and at least one uphole computing device 234 electronically coupled to the uphole antenna 210. The short-range telemetry system 200 also includes a downhole telemetry sub 214 having a downhole antenna 218 and at least one downhole computing device 242 electronically coupled to the downhole antenna 218. The downhole sub 214 may include one or more sensors 22 electronically coupled to the downhole computing device 242. The downhole antenna 218 is located downhole with respect to the uphole antenna 210. As illustrated, the uphole antenna 210 may be configured as a receiving antenna while the downhole antenna 218 may be configured as a transmitting antenna. Throughout this disclosure, the uphole short-range telemetry sub may be referred to as a first short-range telemetry sub and the downhole short-range telemetry sub may be referred to as a second short-range telemetry sub. In addition, the phrase “telemetry sub” may be used interchangeably with the phrase “short-range telemetry sub.”

During use, the downhole antenna 218 is used to create a magnetic field in order to transmit a data signal S over a communications channel, past the one or more downhole tools along the BHA 10, and up to the uphole antenna 210. The communications channel as described herein is a modulated magnetic field generated by a transmitting antenna and received by a receiving antenna. As illustrated, the data signal S may be transmitted uphole via a magnetic field generated by the downhole antenna 218 which is then received or detected by the uphole antenna 210. Upon receiving the data signal S, the uphole computing device 234 may be used to process and route the data signal S to the surface via some other form of telemetry, e.g. mud-pulse telemetry, where it is made available to a system controller and drilling operator.

Referring to FIG. 3, the short-range telemetry system 200 may be configured to operate along the BHA 10 of the drill string 6 in the drilling environment. The housing assembly 202 may carry various components of the short-range telemetry system 200 and other tools typically found in a BHA 10. For example, the housing assembly 202 may also include multiple housing components or subs connected together end-to-end. As shown, the housing assembly 202 has an uphole end 204a, a downhole end 204b opposite the uphole end 204a, and an internal passage (not numbered) that extends along the entire length of the housing assembly 202. The subs that comprise the housing assembly 202 are used to support various tools, such as a rotary steerable tool, a mud motor 224, an MWD tool (not depicted), and a sub at the downhole end 204b for coupling to a bit box 222. An exemplary MWD tool may include encoding and mud pulse telemetry systems that are used to send data to the drilling surface 4. The housings that form the housing assembly 202 include standard threaded connections used in oil & gas drilling systems. The bit box 222 may include a box tool joint for attachment to the drill bit (not depicted). The uphole end 204a may include an attachment means 226 for attachment to an MWD tool (not depicted). It should be appreciated that the short-range telemetry system 200 may be combined or used with any particular downhole tool used in the drilling environment. Typically, the first short-range telemetry sub 206 and the second short-range telemetry sub 214 are separated by a distance between about 30 to 60 feet. In alternative embodiments, however, the first short-range telemetry sub 206 and the second short-range telemetry sub 214 may be separated on the drill string by a distance of greater than 60 feet.

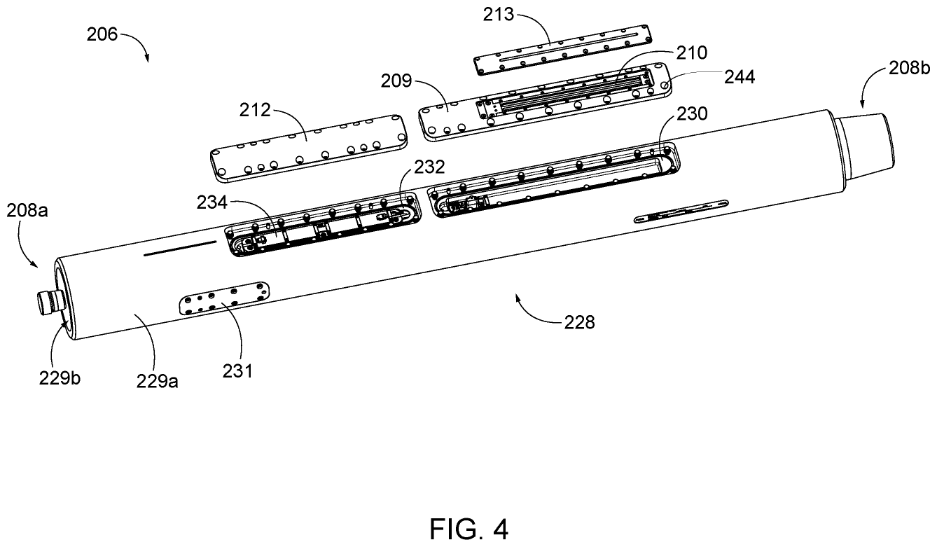

As shown in FIG. 4, the first short-range telemetry sub 206 is configured to carry the uphole antenna 210 and the at least one computing device 234. As shown in FIG. 4, the first short-range telemetry sub 206 is elongated along a central axis (not shown) and has an uphole end 208a and a downhole end 208b opposite the uphole end 208a along the central axis. The first short-range telemetry sub 206 also includes an outer surface 229a and an inner surface 229b. An internal passage extends from the uphole end 208a to the downhole end 208b along the inner surface 229b to permit drilling fluid to pass therethrough. The first short-range telemetry sub 206 has a body 228 with a length that extends from the uphole end 208a to the downhole end 208b. In the present disclosure, the length of the body 228 is between 5.4 and 5.8 feet. In alternative embodiments, however, the length of the body 228 may be less than 5.4 feet or greater than 5.8 feet. In the illustrated embodiment, the first short-range telemetry sub 206 may be located uphole for attachment to an MWD tool (not depicted).

The first short-range telemetry sub 206 includes various hatches that contain components of the telemetry system 200. As illustrated, the first short-range telemetry sub 206 includes a first hatch 230 and a second hatch 232 positioned along the body 228. The first hatch 230 is configured to receive a first hatch cover 209. In one example, the first hatch cover 209 may have a recess (not numbered) that houses the uphole antenna 210 and cover 213 to protect the uphole antenna 210. The hatch cover 209 may be attached by torqued bolts 244, or by any suitable mechanism. The second hatch 232 includes the uphole computing device 234 and other electrical components. The second hatch 232 has a recess that holds the computing device 234 and a second hatch cover 212 to protect the computing device. In the present disclosure, the uphole computing device 234 may control the uphole antenna 210 solely as a receiver, or dually as a receiver/transmitter. The first short-range telemetry sub 206 may also include a small hatch 231 for housing wires and the like to provide a communications channel between the first short-range telemetry sub 206 and an MWD sub or tool (not depicted).

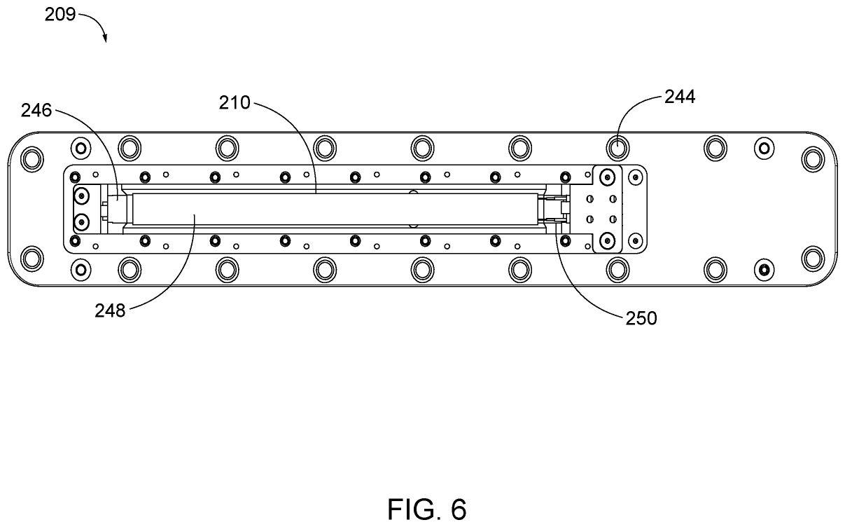

The communications channel is a modulated magnetic field generated by the downhole antenna 218. The magnetic field is received by a coil at the uphole antenna 210. The operation of the mud motor makes the downhole antenna 218 rotate relative to the uphole antenna 210, so the antenna coils are oriented co-axially with the drill string to eliminate any magnetic field modulation due to rotation. Thus, the magnetic field generated by the downhole antenna 218 is not affected in the far field of the uphole antenna 210 by rotation. The downhole antenna 218 may be rotating at a much different speed than the rotation experienced by the uphole antenna 210, with no distortion of the magnetic field. Referring to FIG. 6, in one example, the uphole antenna 210 may include a ferrite rod 246, a magnetic wire coil 248 wound around the ferrite rod 246, and wire leads 250. The ferrite rod 246 may be composed of a ferrite material with high magnetic permeability. In the illustrated embodiment, the magnetic permeability of the ferrite rod 246 may be on the order of 10⁻³. In alternative embodiments, the magnetic permeability may be greater or less than on the order of 10⁻³. In the present disclosure, the ferrite rod 246 has a diameter of 0.625 inches and a length of 11 inches. However, in alternative embodiments, the ferrite rod 246 may vary in dimension. The magnetic wire coil 248 may be a wire similarly used for transformers. In the present disclosure, the magnetic wire coil 248 may be wound around the ferrite rod 246 by 1000 turns. However, in alternative embodiments, the number of wound turns of magnetic wire coil 248 around the ferrite rod 246 may vary. Wire leads 250 from the uphole antenna 210 connect to a signal conditioning electronics board located in the first hatch 230, which is electronically coupled to the uphole computing device 234. In another example, the uphole antenna 210 may be comprised of a laminated steel solenoid-shaped antenna core.

The uphole antenna 210 may be encased within a protective rubber and wire boots. For example, the uphole antenna 210 may be encased within a protective rubber comprising Viton. The protective rubber may protect the uphole antenna 210 from any contact with a conducting fluid, such as water or water-based drilling fluid, which could cause an electrical short. The protective rubber may also provide protection from potentially damaging the uphole antenna 210 due to downhole drilling vibrations.

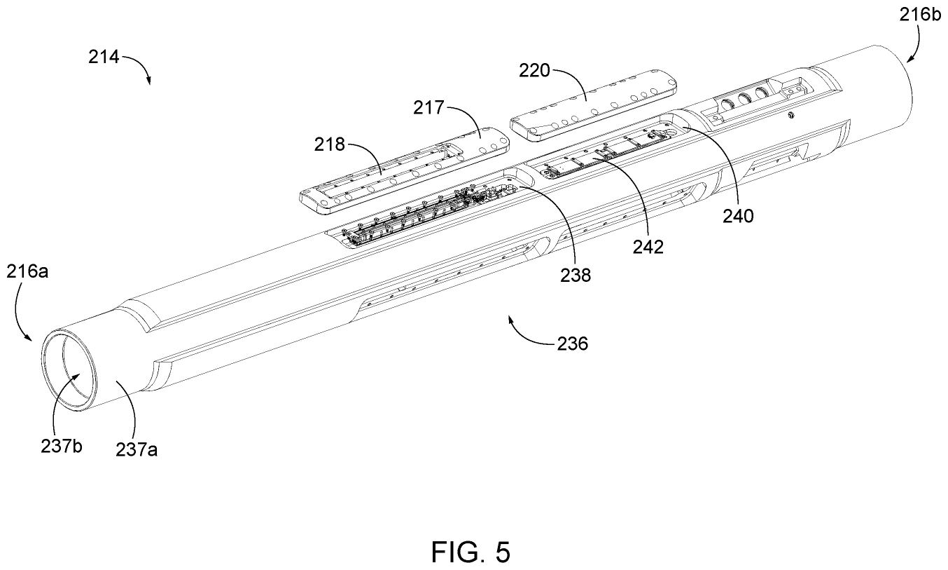

Referring to FIG. 5, the second short-range telemetry sub 214 is also configured to carry the downhole antenna 218 and the at least one computing device 242 and one or more sensors 22 (not depicted). The second short-range telemetry sub 214 has an uphole end 216a and a downhole end 216b opposite the uphole end 216a. The second short-range telemetry sub 214 also has an outer surface 237a and an inner surface 237b. An internal passage extends from the uphole end 216a to the downhole end 216b along the inner surface 237b.

The second short-range telemetry sub 214 may be part of a sub of an RSS tool in the embodiment shown. Alternatively, the second short-range telemetry sub 214 may be separate from the RSS tool (or other tools as the case may be). The second short-range telemetry sub 214 may also include one or more sensors 22 for detecting and measuring drilling, fluid and formation data. Exemplary sensors may include an accelerometer sensor package for measuring inclination, a magnetometer package for measuring rotation, and a gamma sensor for measuring natural formation radioactivity.

the second short-range telemetry sub 214 is elongated along a central axis (not shown). The short-range telemetry sub 214 has a body 236 having a length that extends from the uphole end 216a to the downhole end 216b along the central axis. In the present disclosure, the length of the body 236 is greater than the first short-range telemetry sub 206 and is between 7.5 and 8.3 feet. In alternative embodiments, the length of the body 236 may be less than 7.5 feet or greater than 8.3 feet. In the illustrated embodiment, the second short-range telemetry sub 214 may be located downhole adjacent to or directly coupled to the bit box (not depicted). The second short-range telemetry sub 214 includes a first hatch 238 and a second hatch 240 positioned along the body 236. The first hatch 238 receives the first hatch cover 217 and the first hatch cover 217 includes the downhole antenna 218. The downhole antenna 218 may be positioned inside the first hatch cover 217 such that the downhole antenna 218 may be partially exposed. The second hatch 240 includes the downhole computing device 242. The second hatch 240 receives the second hatch cover 220 to cover the downhole computing device 242. In the present disclosure, the downhole computing device 242 may control the downhole antenna 218 solely as a transmitter, or dually as a transmitter/receiver.

The communications channel is a modulated magnetic field generated by the downhole antenna comprising a ferrite core and a wire coil wound around the core. The magnetic field is received at the uphole antenna 210. The operation of the mud motor makes the downhole antenna 218 rotate relative to the uphole antenna 210, so the antenna coils are oriented co-axially with the drill string to eliminate any magnetic field modulation due to rotation. Referring to FIG. 6, in one example, the downhole antenna 218 may include a ferrite rod 246, a magnetic wire coil 248 wound around the ferrite rod 246, and wire leads 250. The ferrite rod 246 may be composed of a ferrite material with high magnetic permeability. In the illustrated embodiment, the magnetic permeability of the ferrite rod 246 may be on the order of 10⁻³. In alternative embodiments, the magnetic permeability may be greater or less than on the order of 10⁻³. In the present disclosure, the ferrite rod 246 has a diameter of 0.625 inches and a length of 11 inches. However, in alternative embodiments, the ferrite rod 246 may have variable dimensions. The magnetic wire coil 248 may be a wire similarly used for transformers. In the present disclosure, the magnetic wire coil 248 may be wound around the ferrite rod 246 by 1000 turns. However, in alternative embodiments, the number of wound turns of magnetic wire coil 248 around the ferrite rod 246 may vary. Wire leads 250 from the downhole antenna 218 connect to a signal conditioning electronics board located in the first hatch 238, which are electronically coupled to the downhole computing device 242. In another example, the downhole antenna 218 may be comprised of a laminated steel solenoid-shaped antenna core.

The downhole antenna 218 may be encased within a protective rubber and wire boots. For example, the downhole antenna 218 may be encased within a protective rubber comprising Viton. The protective rubber may protect the downhole antenna 218 from any contact with a conducting fluid, such as water or water-based drilling fluid, which could cause an electrical short. The protective rubber may also provide protection from potentially damaging the downhole antenna 218 due to downhole drilling vibrations.

In alternative embodiments, the contents of the first short-range telemetry sub 206 and the second short-range telemetry sub 214 may be located on the housing assembly 202 rather than being contained in a sub.

In the illustrated embodiment, during drilling operations, the downhole antenna 218 communicates and transmits drilling data detected and measured by sensors to the uphole antenna 210, shown in FIG. 3 and FIG. 4, in the first short-range telemetry sub 206. The uphole computing device 234 is configured to filter the received signal to generate a filtered signal, convert the filtered signal to a digital signal, process the digital signal to reduce signal noise, demodulate the digital signal and transmit the digital signal to a location uphole or above the surface 4. The uphole computing device 234 may further access the data and signal communication information detected by the uphole antenna 210, identify a communication setting with reduced noise based on the analyzed information, and instruct the downhole antenna 218, shown in FIG. 3 and FIG. 5, to transmit signals in accordance with the communication setting. The downhole antenna 218 subsequently transmits signals in accordance with the reduced-noise setting, minimizing noise introduction and clipping distortion of the subsequent signals.

During drilling operations, the downhole antenna 218 may act as a transmitting antenna and the uphole antenna 210 may act as a receiving antenna. The downhole antenna 218 may therefore communicate and transmit drilling data detected and measured by the sensors in the second short-range telemetry sub 214 to the uphole antenna 210. The uphole computing device 234 may be configured to filter the received signal to generate a filtered signal, convert the filtered signal to a digital signal, process the digital signal to reduce signal noise, demodulate the digital signal and transmit the digital signal to a location uphole or above the surface 4. The uphole computing device 234 may acquire, process, and record data and signal communication information detected by the uphole antenna 210. Signal communication information may include a wideband frequency spectrum of the signal, ambient spectral noise energy of the transmission channel, as well as signal gain and filtering values. The uphole computing device 234 may further access the data and signal communication information detected by the uphole antenna 210. In response, the uphole computing device 234 may then identify the data to determine a preferred communication setting with reduced noise. In the illustrated embodiment, the preferred communication setting is a recommended quieter transmission bandwidth. The uphole computing device 234 then instructs the uphole antenna 210 to transmit this setting to the downhole antenna 218 as an instruction to transmit signals in accordance with the setting. The downhole computing device 242 processes the instruction and makes the necessary changes downhole in order to transmit signals in accordance with the preferred communication setting.

The short-range telemetry system 200 therefore introduces as little noise during signal processing and conversion as possible so as to not further degrade a received Eb/No metric, which is indicative of the power efficiency of the communications channel. By reducing the number of processing stages and amplification to a minimum, the opportunities for noise introduction and clipping distortion are minimized. This provides a lower bit error rate and enhanced communications performance.

In the illustrated embodiment, the short-range telemetry system 200 may be used for uphole communications from the downhole antenna 218 to the uphole antenna 210. However, in alternative embodiments, the short-range telemetry system 200 may be a two-way communications system where the downhole computing device 242 may switch the function of the downhole antenna 218 from a transmitting antenna to a receiving antenna, and the uphole computing device 234 may switch the function of the uphole antenna 210 from a receiving antenna to a transmitting antenna. In this configuration, the downhole computing device 242 may be configured to process and transmit received signals and communication in a manner equivalent to the uphole computing device 234.

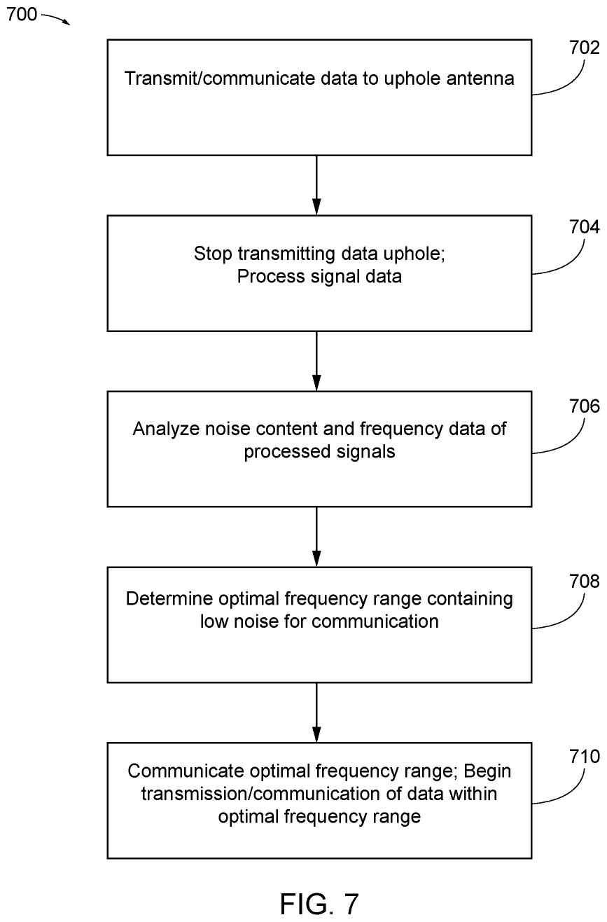

Now referring to FIG. 7, a method 700 for providing adaptive communication between the downhole antenna 218 and the uphole antenna 210 in the short-range telemetry system 200 shown in FIG. 3, will be described. First, in step 702 the downhole antenna 218 transmits signals regarding drilling data and signal communication information to the uphole antenna 210 during drilling. The uphole computing device 234 may acquire, process, and record data and signal communication information detected by the uphole antenna 210. The signal communication information may include a wideband frequency spectrum of the signal, ambient spectral noise energy of the transmission channel, as well as signal gain and filtering values. In step 704, upon entering at a drilling rest period, the downhole antenna 218 stops transmitting information and data to the uphole antenna 210 and the transmitted signals are subsequently processed. In step 706, the uphole computing device 234 analyzes the frequency and noise data of the corresponding processed signals. In step 708, the uphole computing device 234 determines a recommended quieter transmission bandwidth, which includes the best frequency range containing the lowest noise energy region to transmit signals between the downhole antenna 218 and the uphole antenna 218. In alternative embodiments, the uphole computing device 234 may determine the frequency range that either corresponds to a low noise energy region or high signal strength region or that does not correspond to a high noise energy region or low signal strength region. In step 710, the uphole computing device 234 then transmits the optimal frequency range to the downhole antenna and the downhole antenna 218 processes the transmission and begins to transmit subsequent signals within the determined optimal frequency. This method also applies to the downhole computing device 242 when the uphole antenna 210 acts as a transmitting antenna and the downhole antenna 218 acts as a receiving antenna.

In addition to adaptive communication, the method 700 enables raw signal processing and data demodulation, and provides the capability to report quantitative signal quality measurements including total power, relative transmission frequency power levels, background noise levels, and symbol synchronization alignment on a continuous basis when queried.

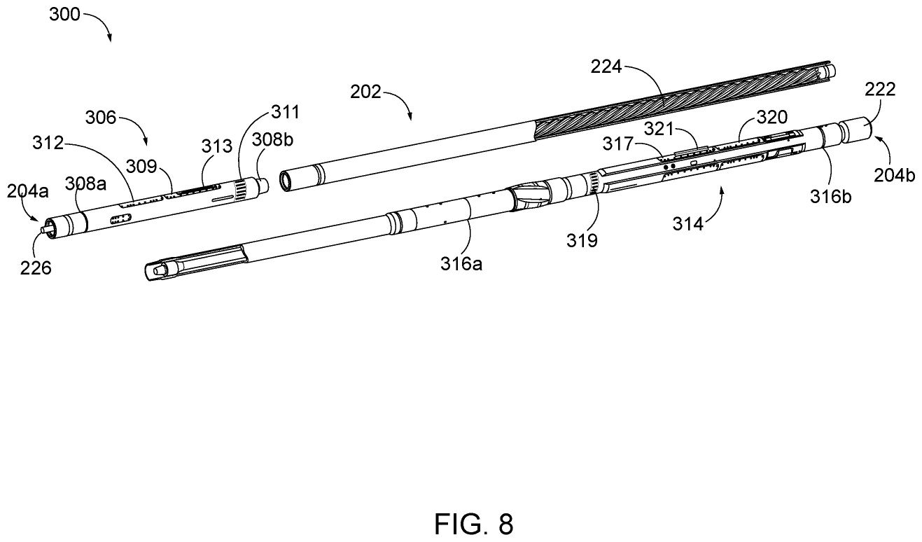

FIG. 8 is a perspective view of a magnetic short-range telemetry system 300 implemented on a drilling tool, according to another embodiment of the present disclosure. The short-range telemetry system 300 may be configured to operate along the BHA 10 of the drill string 6 shown in FIG. 1, in the drilling environment. The short-range telemetry system 300 may have the same housing assembly 202 of the short-range telemetry system 200 shown in FIG. 3 and described above. Therefore, features that are common between the system 200 shown in FIG. 3 and the system 300 shown in FIG. 8 will have the same reference numbers. The housing assembly 202 carries the components of the short-range telemetry system 300. The housing assembly 202 thus includes the uphole end 204a, the downhole end 204b opposite the uphole end 204a, and the internal passage (not numbered) that extends along the entire length of the housing assembly 202. As illustrated, the short-range telemetry system 300 is implemented with a mud motor 224 and a rotary steerable tool 314. However, the short-range telemetry system 300 may be combined with any downhole tool used in the drilling environment.

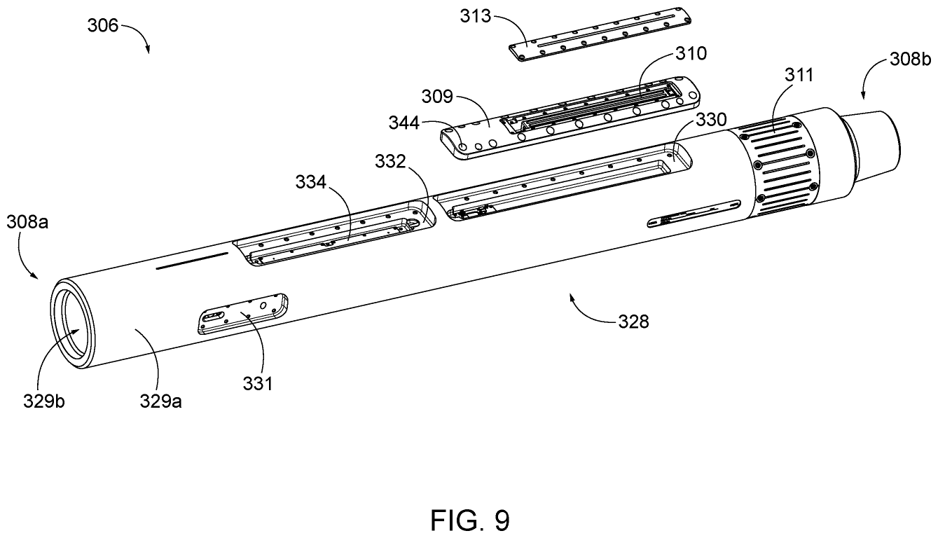

The short-range telemetry system 300 includes a first short-range telemetry sub 306 and a second short-range telemetry sub 314 located downhole from the first short-range telemetry sub 306. In the present disclosure, the first short-range telemetry sub 306 and the second short-range telemetry sub 314 may be separated on the drill string by a distance between about 30 to 60 feet. In alternative embodiments, however, the first short-range telemetry sub 306 and the second short-range telemetry sub 314 may be separated on the drill string by a distance of greater than 60 feet. As shown in FIG. 9, the first short-range telemetry sub 306 has an uphole transmitting antenna 310 and an uphole receiving antenna 311 and at least one uphole computing device 334 electronically coupled to the uphole transmitting antenna 310 and the uphole receiving antenna 311. The first short-range telemetry sub 306 is elongated along a central axis (not shown) and has an uphole end 308a, a downhole end 308b opposite the uphole end 308a along the central axis, an outer surface 329a, and an inner surface 329b. An internal passage extends from the uphole end 308a to the downhole end 308b along the inner surface 329b to permit drilling fluid to pass therethrough. The first short-range telemetry sub 306 has a body 328 with a length that extends from the uphole end 308a to the downhole end 308b. In the present disclosure, the length of the body 328 is between 5.8 and 6.4 feet. In alternative embodiments, the length of the body may be less than 5.8 feet or greater than 6.4 feet. In the illustrated embodiment, the first short-range telemetry sub 306 may be located uphole for attachment to an MWD tool (not depicted).

The first short-range telemetry sub 306 includes various hatches that contain components of the telemetry system 300. As illustrated, the first short-range telemetry sub 306 includes a first hatch 330 and a second hatch 332 positioned along the body 328. The first hatch 330 is configured to receive a first hatch cover 309. In one example, the first hatch cover 309 may have a recess (not numbered) that houses the uphole antenna 310. The hatch cover 309 may be attached by torqued bolts 344, or by any suitable mechanism. The second hatch 332 includes the uphole computing device 334 and other electrical components. The second hatch 332 has a recess that holds the computing device 334. The first short-range telemetry sub 306 may also include a small hatch 331 for housing wires and the like to provide a communications channel between the first short-range telemetry sub 306 and an MWD sub or tool (not depicted).

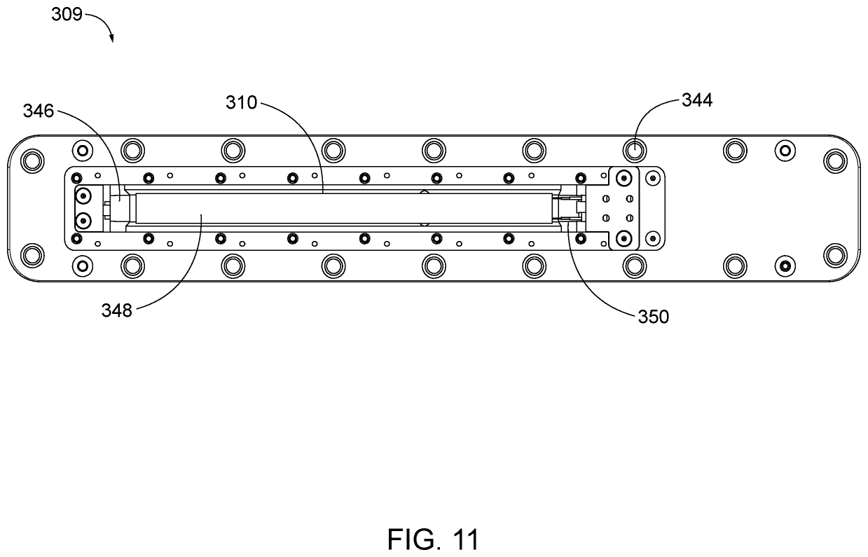

As illustrated, the uphole receiving antenna 311 is a metal antenna. The uphole receiving antenna 311 loops around the circumference of the outer surface 329a of the body 328 of the first short-range telemetry sub 306. In an alternative embodiment, the uphole receiving antenna 311 is an air core antenna. Referring to FIG. 11, in one example, the uphole transmitting antenna 310 may include a ferrite rod 346, a magnetic wire coil 348 wound around the ferrite rod 346, and wire leads 350. The ferrite rod 346 may be composed of a ferrite material with high magnetic permeability ferrite material. In the illustrated embodiment, the magnetic permeability of the ferrite rod 346 may be on the order of 10⁻³. In alternative embodiments, the magnetic permeability may be greater or less than on the order of 10⁻³. In the present disclosure, the ferrite rod 346 has a diameter of 0.625 inches and a length of 11 inches. However, in alternative embodiments, the ferrite rod 346 may be variable in length. The magnetic wire coil 348 may be a wire similarly used for transformers. In the present disclosure, the magnetic wire coil 348 may be wound around the ferrite rod 346 by 1000 turns. However, in alternative embodiments, the number of wound turns of magnetic wire coil 348 around the ferrite rod 346 may vary. Wire leads 350 from the uphole transmitting antenna 310 connect to a signal conditioning electronics board located in the first hatch 330, which is electronically coupled to the uphole computing device 334. In another example, the uphole transmitting antenna 310 may be comprised of a laminated steel solenoid-shaped antenna core.

The uphole transmitting antenna 310 may be encased within a protective rubber and wire boots. For example, the uphole transmitting antenna 310 may be encased within a protective rubber comprising Viton. The protective rubber may protect the uphole transmitting antenna 310 from any contact with a conducting fluid, such as water or water-based drilling fluid, which could cause an electrical short. The protective rubber may also provide protection from potentially damaging the uphole transmitting antenna 310 due to downhole drilling vibrations.

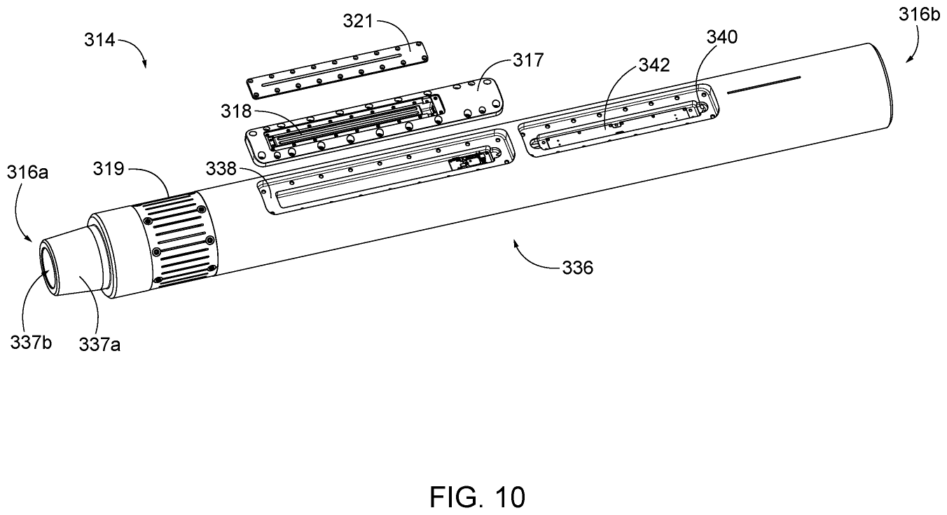

Referring to FIG. 10, the second short-range telemetry sub 314 has a downhole transmitting antenna 318, a downhole receiving antenna 319 and at least one downhole computing device 342 electronically coupled to the downhole transmitting antenna 318 and the downhole receiving antenna 319. The second short-range telemetry sub 314 is also configured to carry one or more sensors (not depicted). The second short-range telemetry sub 314 has an uphole end 316a and a downhole end 316b opposite the uphole end 316a. The second short-range telemetry sub 314 may be part of a sub of an RSS tool in the embodiment shown. Alternatively, the second short-range telemetry sub 314 may be separate from the RSS tool (or other tools as the case may be). The second short-range telemetry sub 314 may also include one or more sensors 22, as shown in FIG. 1 and FIG. 2A, for detecting and measuring drilling data. Exemplary sensors may include an accelerometer sensor package for measuring inclination, a magnetometer package for measuring rotation, and a gamma sensor for measuring natural formation radioactivity.

The second short-range telemetry sub 314 is elongated along a central axis (not shown). The second short-range telemetry sub 314 has a body 336 having a length that extends from the uphole end 316a to the downhole end 316b along the central axis. In the present disclosure, the length of the body 336 is between 5.4 and 6.4 feet. In alternative embodiments, the length of the body 336 may be less than 5.4 feet or greater than 6.4 feet. The short-range telemetry sub 314 also has an outer surface 337a and an inner surface 337b. In the illustrated embodiment, the second short-range telemetry sub 314 may be located downhole adjacent to or directly coupled to the drill bit (not depicted). The second short-range telemetry sub 314 includes a first hatch 338 and a second hatch 340 positioned along the body 336. The first hatch 338 receives the first hatch cover 317 and the first hatch cover 317 includes the downhole transmitting antenna 318. The downhole transmitting antenna 318 may be positioned inside the first hatch cover 317 such that the downhole transmitting antenna 318 may be partially exposed. In one example, the first hatch cover 317 may have a recess (not numbered) that houses the downhole transmitting antenna 318 and cover 321 to protect the downhole transmitting antenna 318. The second hatch 340 includes the downhole computing device 342.

As illustrated, the downhole receiving antenna 319 is a metal-shielded antenna. The downhole receiving antenna 319 loops around the circumference of the outer surface 329a of the body 328 of the first short-range telemetry sub 306. In one embodiment, this antenna may have a metal core. In an alternative embodiment, the downhole receiving antenna 319 is an air core antenna. Referring to FIG. 11, in one example, the downhole transmitting antenna 318 may include a ferrite rod 346, a magnetic wire coil 348 wound around the ferrite rod 346, and wire leads 350. The ferrite rod 346 may be composed of a ferrite material with high magnetic permeability. In the illustrated embodiment, the magnetic permeability of the ferrite rod 346 may be on the order of 10⁻³. In alternative embodiments, the magnetic permeability may be greater or less than on the order of 10⁻³. In the present disclosure, the ferrite rod 346 has a diameter of 0.625 inches and a length of 11 inches. However, in alternative embodiments, the ferrite rod 346 may have variable dimensions. The magnetic wire coil 348 may be a wire similarly used for transformers. In the present disclosure, the magnetic wire coil 348 may be wound around the ferrite rod 346 by 1000 turns. However, in alternative embodiments, the number of wound turns of magnetic wire coil 348 around the ferrite rod 346 may vary. Wire leads 350 from the downhole transmitting antenna 318 connect to a signal conditioning electronics board located in the first hatch 338, which is electronically coupled to the downhole computing device 342. In another example, the downhole transmitting antenna 318 may be comprised of a laminated steel solenoid-shaped antenna core.

The downhole transmitting antenna 318 may be encased within a protective rubber and wire boots. For example, the downhole transmitting antenna 318 may be encased within a protective rubber comprising Viton. The protective rubber may protect the downhole transmitting antenna 318 from any contact with a conducting fluid, such as water or water-based drilling fluid, which could cause an electrical short. The protective rubber may also provide protection from potentially damaging the downhole transmitting antenna 318 due to downhole drilling vibrations.

In alternative embodiments, the contents of the first short-range telemetry sub 306 and the second short-range telemetry sub 314 may be located on the housing assembly 202 rather than being contained in a sub.

In the illustrated embodiment, during drilling operations, the downhole transmitting antenna 318 communicates drilling and other data detected by the sensors in the second short-range telemetry sub 314 to the uphole receiving antenna 311 in the first short-range telemetry sub 306. The uphole computing device 334 is configured to filter the received signals to generate a filtered signal, convert the filtered signal to a digital signal, process the digital signal to reduce the signal noise, demodulate and decode the digital signal and transmit a decoded digital signal to a location uphole or above the surface. Further, the uphole computing device 334 may record additional data and signal communication information detected by the uphole receiving antenna 311. Signal communication information may include a wideband frequency spectrum of the signal and the channel, ambient spectral noise energy of the transmission channel, as well as signal gain, filtering values, and other pertinent communications parameters. The uphole computing device 334 may then identify preferred communication settings to either reduce noise or increase signal energy. In the illustrated embodiment, the preferred communication setting is a recommended quieter transmission bandwidth, along with a recommended center transmission frequency. The uphole computing device 334 instructs the uphole transmitting antenna 310 to transmit these settings to the downhole receiving antenna 319. The downhole computing device 342 processes the received information, and adjusts the downhole transmitting antenna 318 for the new settings. This completed process may optimize uphole reception and downhole transmission, and may be repeatedly performed.

In addition, similar operations may optimize downhole reception and uphole transmission. During drilling operations, the uphole transmitting antenna 310 communicates data or instructions from the first short-range telemetry sub 306 to the downhole receiving antenna 319 on the second short-range telemetry sub 314. The downhole computing device 342 is configured to filter the received signals to generate a filtered signal, convert the filtered signal to a digital signal, process the digital signal to reduce the signal noise, and demodulate and decode the digital signal. Further, the downhole computing device 342 may record additional data and signal communication information detected by the downhole receiving antenna 319. Signal communication information may include a wideband frequency spectrum of the signal and the channel, ambient spectral noise energy of the transmission channel, as well as signal gain, filtering values, and other pertinent communications parameters. The downhole computing device 342 may then identify preferred communication settings to either reduce noise or increase received signal energy. In the illustrated embodiment, the preferred communication setting is a recommended quieter transmission bandwidth, along with a recommended center transmission frequency. The downhole computing device 342 then instructs the downhole transmitting antenna 318 to transmit the new settings from the second short-range telemetry sub 314 to the receiving antenna 311 in the first short-range telemetry sub 306. The uphole computing device 334 obtains the new instructions and adjusts the setting for the uphole transmitting antenna 310. This completed process may optimize downhole reception and uphole transmission, and may be repeatedly performed.

The processes outlined in sections {0058} and {0059} describe a repetitive process of optimization of transmitting and receiving frequencies for the transmitting and receiving antennas. The settings, specifically the frequency bandwidth and center transmitting frequencies, may well differ between the uphole short-range telemetry sub 306 and the downhole short-range telemetry sub 314, reflecting the fact that they may be located in different noise environments. As those environments may change due to influences such as drilling interactions with the earth formations, drilling fluid flow circulation, drillstring vibrations, motor vibrations and similar, these optimization processes are continuously repeated. By such means the short-range telemetry system 300 therefore introduces as little noise during signal processing and conversion as possible, and provides for a high signal transmission energy, so as not to degrade the Eb/No communications metric, and to minimize the bit error rate.

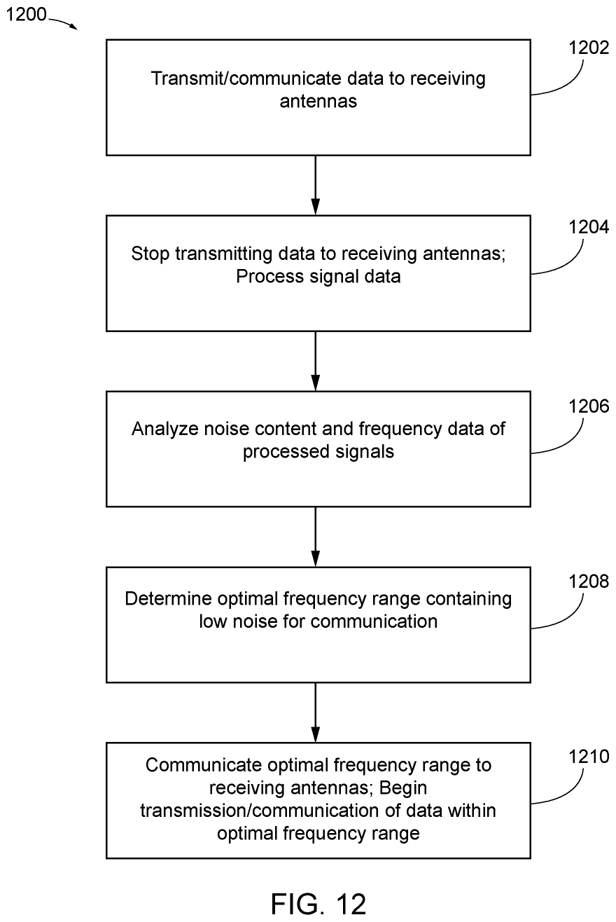

Now referring to FIG. 12, a method 1200 for providing adaptive communication between the uphole transmitting antenna 310 and the downhole receiving antenna 319, and the downhole transmitting antenna 318 and the uphole receiving antenna 311, in the short-range telemetry system 300 shown in FIG. 8, will be described. First, in step 1202, the downhole transmitting antenna 318 transmits signals regarding drilling data and signal communication data to the uphole receiving antenna 311 during drilling. The uphole transmitting antenna 310 transmits signals regarding drilling data and signal communication data to the downhole receiving antenna 319. The uphole computing device 334 and the downhole computing device 342 may acquire, process and record data and signal communication information detected by the uphole receiving antenna 311 and the downhole receiving antenna 319. The signal communication information may include a wideband frequency spectrum of the signal and channel, ambient spectral noise energy of the transmission channel, as well as signal gain and filtering values. In step 1204, upon entering a drilling rest period, the uphole transmitting antenna 310 stops transmitting information to the downhole receiving antenna 319, and the downhole transmitting antenna 318 stops transmitting information to the uphole receiving antenna 311. The signals and signal communications information are subsequently processed. In step 1206, the uphole computing device 334 and the downhole computing device 342 analyze frequency and noise data. In step 1208, the uphole computing device 334 determines a recommended transmission center frequency and a recommended quieter transmission bandwidth to transmit signals between the downhole transmitting antenna 318 and the uphole receiving antenna 311. The downhole computing device 342 determines a recommended transmission center frequency and a recommended quieter transmission bandwidth to transmit signals between the uphole transmitting antenna 310 and the downhole receiving antenna 319. In alternative embodiments, the uphole computing device 334 and the downhole computing device 342 may determine the frequency range that either corresponds to a low noise energy region or high signal strength region or that does not correspond to a high noise energy region or low signal strength region. In step 1210, the uphole computing device 334 commands the uphole transmitting antenna 310 to transmit the optimal receiving center frequency to the downhole receiving antenna 319, which upon receipt the downhole computing device 342 adjusts the optimal transmitting center frequency for the downhole transmitting antenna 318. The downhole computing device 342 commands the downhole transmitting antenna 318 to transmit the optimal receiving center frequency to the uphole receiving antenna 311, which upon receipt the uphole computing device 334 adjusts the optimal transmitting center frequency for the uphole transmitting antenna 310. By these means, each short-range transmitting antenna transmits data at a center frequency which is optimal for each receiving antenna.

In addition to adaptive communication, the method 1200 enables raw signal processing and data demodulation, and provides the capability to report quantitative signal quality measurements including total power, relative transmission frequency power levels, background noise levels, and symbol synchronization alignment on a continuous basis when queried.

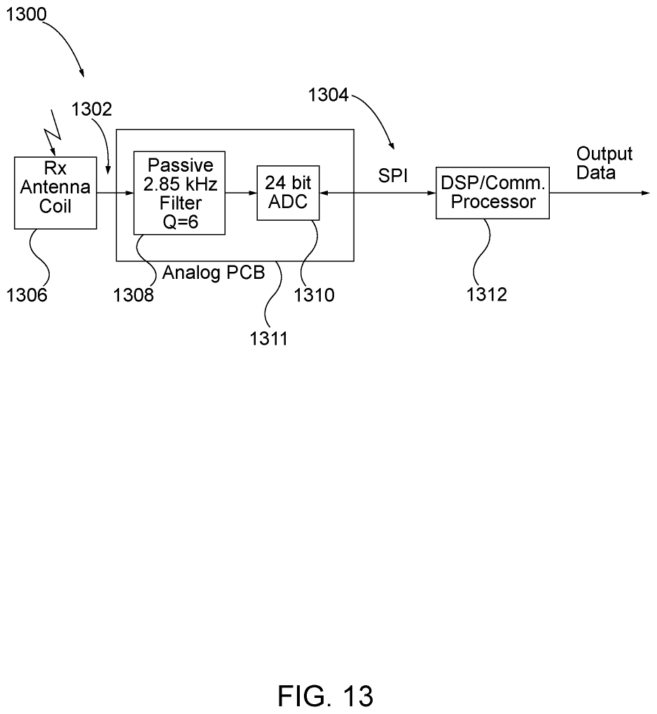

FIG. 13 is a block diagram of signal processing components of a short-range telemetry sub comprising an antenna. In the illustrated embodiment, the antenna is configured to act as a receiving antenna. The signal processing components include an analog signal processing chain 1302 and a digital signal processing chain 1304. The analog signal processing chain 1302 includes a receiving antenna 1306, a passive filter 1308 and an analog to digital converter (“ADC”) 1310. The passive filter 1308 and the ADC are coupled via a printed circuit board (“PCB”) 1311. The digital signal processing chain 1304 includes the ADC 1310 and a digital signal computing device 1312 connected via a simple unidirectional serial peripheral interface (“SPI”)-type bus.

In the analog signal processing chain 1302, the signal is received by the receiving antenna 1306. The receiving antenna 1306 consists of a very small signal voltage source in series with a coil inductance and resistance. A capacitor may be added across the terminals, forming a resonant low pass second order LCR filter. In addition, series damping resistance may be increased to provide an optimally flat passband. This configuration is beneficial for a frequency sweep test to find an optimal transmission frequency. The signal passes through the passive filter 1306 and is subsequently converted to a digital signal by the ADC 1310 in the PCB 1311 and enters the digital signal processing chain 1304. The analog signal processing chain 1302 provides a signal to noise margin of approximately 20 decibels (“dB”). In alternative embodiments, an additional low noise gain stage may be added to reduce the input referred noise to the level of the amplifier circuitry and optimize the total system noise. The additional low noise gain stage may include using a suitable low noise high temperature operational amplifier in the PCB 1311 and subsequently passing the signal through the ADC 1310 outside of the PCB 1311.

In the present disclosure, the ADC 1310 is a suitable high-temperature 24-bit delta-sigma ADC and can be operated at a clock rate of 7.3728 MHz. However, in alternative embodiments, the ADC 1310 may be operated at variable clock rates. The ADC 1310 may have multiple differential inputs that require an external buffer input capacitor to support the input sampling capacitance. Having more than one differential input allows measurements at different points in the signal chain at the same time. This configuration enables direct antenna measurement as well as after a gain or filter stage. A discrete Fourier transform can be applied to demodulate the signal at whatever frequencies are sent by the transmitter. The digital signal is then processed by the digital signal computing device 1312. Signal processing algorithms included in digital signal computing device 1312 identify and recognize a desired energy per bit of data (Eb) and the data rate. The digital signal computing device 1312 also determines the maximum allowable in-band noise power spectral density (No). If the Eb/No ratio drops below a desired or required value (i.e. when the bit error rate has increased), the signal processing algorithms may compute a quieter frequency bandwidth in which to operate. The output from this signal processing conducted by the uphole short-range telemetry sub's electronics—i.e., a recommended quieter transmission bandwidth—is transmitted to the receiving antenna of the downhole short-range telemetry sub, where the electronics of the downhole short-range telemetry sub processes this recommendation and makes the change to the new frequencies.

Existing short-range telemetry configurations exhibit less than ideal performance in real world conditions in a drilling environment. Communications performance may be evaluated by measuring the bit error rate. The bit error rate is primarily a function of received energy per bit divided by the in-band signal noise spectral density, or the Eb/NO figure. The higher the Eb/NO figure, the lower the resulting random bit error rate. The receiver must therefore not only detect very small signal levels, but must also make sure the noise energy is as small as possible. Existing short-range telemetry configurations, however, boost the signal level by applying analog signal gains of tens of thousands using several stages of fixed and variable gain amplifiers. Each additional stage of amplification also adds to the base noise level while also amplifying any noise in the receiving antenna signal. This only serves to degrade the signal to noise ratio.

Existing magnetic telemetry transmitting antenna configurations generate a magnetic field whose field intensity falls off as the inverse cube of distance. The received signal bit energy is proportional to the square of the signal intensity, so the energy is reduced by a factor of 64 for every doubling of distance. This results in very small received signal levels at the target distance. Existing receiving antenna configurations boost the received signal level by using several stages of fixed and variable gain amplifiers, amplifying noise in the receiving antenna signal. In addition to high signal gain, current short-range telemetry configurations provide an increased risk of non-linear distortion due to wideband signal filtering. The existing receiving antenna picks up magnetic noise energy over a frequency range in excess of the signal bandwidth, which can create a wideband noise energy that is larger in amplitude than the signal amplitude. Thus, applying a wideband preamplifier to the antenna signal can overload the amplifier and result in clipping before the desired signal levels are amplified enough to detect. Embodiments of the present disclosure have several advantages over conventional systems, such as reducing the number of signal processing stages and amplification, and creating a higher signal bit error rate figure, which thereby minimizes noise introduction and clipping distortion.

The present disclosure is described herein using a limited number of embodiments, these specific embodiments are not intended to limit the scope of the disclosure as otherwise described and claimed herein. Modification and variations from the described embodiments exist. More specifically, the following examples are given as a specific illustration of embodiments of the claimed disclosure. It should be understood that the invention is not limited to the specific details set forth in the examples.

1. A system configured to operate along a bottom hole assembly of a drill string in a downhole drilling environment, the system comprising:
a first short-range telemetry sub having a first antenna;
a second short-range telemetry sub having a second antenna, and separated from the first short-range telemetry sub by one or more components of the bottom hole assembly;
a first computing device coupled to the first antenna of the first short-range telemetry sub; and
a second computing device coupled to the second antenna of the second short-range telemetry sub,
wherein either the first computing device and the second computing device are configured to, in response to either the first antenna or the second antenna, respectively, receiving a signal:
a) filter the received signal to generate a filtered signal, b) convert the filtered signal to a digital signal, and c) process the digital signal to reduce signal noise.

2. The system of claim 1, wherein either or both of the first computing device and the second computing device are further configured to demodulate the digital signal and transmit the digital signal to a location uphole or downhole.

3. The system of claim 1, wherein the first computing device is configured to selectively operate the first antenna as a receiving antenna or a transmitting antenna.

4. The system of claim 1, wherein the second computing device is configured to selectively operate the second antenna as a receiving antenna or a transmitting antenna.

5. The system of claim 1, wherein the first computing device operates the first antenna as a receiving antenna and the second computing device operates the second antenna as a transmitting antenna, wherein the first computing device is configured to:
access communication information detected by the receiving antenna;
identify a communication setting based on the communication information; and
instruct the transmitting antenna to transmit signals in accordance with the communication setting.

6. The system of claim 5, wherein the communication information includes a frequency band having a low noise energy region or a high signal strength region.

7. The system of claim 6, wherein the communication setting is the frequency band having the low noise energy region or the high signal strength region.

8. The system of claim 6, wherein the communication setting is a frequency band that does not correspond to the high noise energy region or the low signal strength region.

9. The system of claim 1, further comprising at least one sensor configured to obtain drilling data indicative of one or more drilling parameters.

10. The system of claim 9, wherein the at least one sensor is one of an accelerometer, a magnetometer, or a strain gauge.

11. The system of claim 9, wherein the one or more drilling parameters includes tool inclination, tool face angle, azimuth, drill string rotational speed, temperature, pressure, mud motor speed, gamma radiation, or mud resistivity.

12. The system of claim 1, wherein the first short-range telemetry sub further comprises a sub body defining a first end, a second end spaced from the first end along a central axis, an outer surface, an inner surface, an internal passage that extends from the first end to the second end and is defined by the inner surface, a first hatch that carries the first antenna of the first short-range telemetry sub, and a second hatch configured to contain the first computing device.

13. The system of claim 1, wherein the second short-range telemetry sub further comprises a sub body defining a first end, a second end spaced from the first end along a central axis, an outer surface, an inner surface, an internal passage that extends from the first end to the second end and is defined by the inner surface, a first hatch that carries the second antenna of the second short-range telemetry sub, and a second hatch configured to contain the second computing device.

14. The system of claim 1, wherein at least one of the first antenna of the first short-range telemetry sub and the second antenna of the second short-range telemetry sub include a high magnetic permeability ferrite core and a solenoid magnetic wire coil wrapped around the high magnetic permeability ferrite core.

15. The system of claim 1, wherein at least one of the first antenna of the first short-range telemetry sub and the second antenna of the second short-range telemetry sub include a non-ferrite metallic substrate and a wire coil wrapped upon the non-ferrite metallic substrate.

16. The system of claim 1, wherein the first antenna includes a high magnetic permeability ferrite core and a solenoid magnetic wire coil wrapped around the high magnetic permeability ferrite core, and the second antenna includes a non-ferrite metallic substrate and a wire coil wrapped upon the non-ferrite metallic substrate.

17. A system configured to operate along a bottom hole assembly of a drill string in a downhole drilling environment, the system comprising:
a first short-range telemetry sub having at least one transmitting antenna and at least one receiving antenna;
a second short-range telemetry sub having at least one transmitting antenna and at least one receiving antenna and separated from the first short-range telemetry sub by one or more components of the bottom hole assembly;
a first computing device coupled to the at least one transmitting antenna and the at least one receiving antenna of the first short-range telemetry sub; and
a second computing device coupled to the at least one transmitting antenna and the at least one receiving antenna of the second short-range telemetry sub,
wherein at least one of the first computing device and the second computing device are each configured to, in response to receiving a respective signal, a) filter the received signal to generate a filtered signal, b) convert the filtered signal to a digital signal, c) and d) process the digital signal to reduce signal noise.

18. The system of claim 17, wherein the first computing device and the second computing devices are further configured to, respectively, demodulate the digital signal and cause the transmission of the digital signal to a location uphole.

19. The system of claim 17, wherein the first computing device and the second computing devices are further configured to:
access communication information detected by the at least one receiving antenna of the first short-range telemetry sub or the second short-range telemetry sub;
identify a communication setting based on the communication information; and
instruct the at least one transmitting antenna of the first short-range telemetry sub or the second short-range telemetry sub to transmit signals in accordance with the communication setting.

20. The system of claim 19, wherein the communication information includes a frequency band having a high signal strength region or a low noise energy region.

21. The system of claim 20, wherein the communication setting is the frequency band having the high signal strength region or the low noise energy region.

22. The system of claim 20, wherein the communication setting is a frequency band that does not correspond to the high noise energy region or the low signal strength region.

23. The system of claim 17, further comprising at least one sensor configured to obtain drilling data indicative of one or more drilling parameters.

24. The system of claim 23, wherein the at least one sensor is one of an accelerometer, a magnetometer, or a strain gauge.

25. The system of claim 23, wherein the one or more drilling parameters includes tool inclination, tool face angle, azimuth, drill string rotational speed, temperature, pressure, mud motor speed, gamma radiation, or mud resistivity.

26. The system of claim 17, wherein the at least one transmitting antenna of the first short-range telemetry sub is configured to communicate with the at least one receiving antenna of the second short-range telemetry sub, and the at least one transmitting antenna of the second short-range telemetry sub is configured to communicate with the at least one receiving antenna of the first short-range telemetry sub.

27. The system of claim 17, wherein the first short-range telemetry sub further comprises a sub body defining a first end, a second end spaced from the first end along a central axis, an outer surface, an inner surface, an internal passage that extends from the first end to the second end and is defined by the inner surface, a first hatch that carries at least one of the at least one transmitting antenna or the at least one receiving antenna of the first short-range telemetry sub, and a second hatch configured to contain the first computing device.

28. The system of claim 17, wherein the second short-range telemetry sub further comprises a sub body defining a first end, a second end spaced from the first end along a central axis, an outer surface, an inner surface, an internal passage that extends from the first end to the second end and is defined by the inner surface, a first hatch that carries at least one of the at least one transmitting antenna or the at least one receiving antenna of the second short-range telemetry sub, and a second hatch configured to contain the second computing device.

29. The system of claim 17, wherein the at least one transmitting antenna of the first short-range telemetry sub and the at least one transmitting antenna of the second short-range telemetry sub each include a high magnetic permeability ferrite core and a solenoid magnetic wire coil wrapped around the high magnetic permeability ferrite core.

30. The system of claim 17, wherein the at least one transmitting antenna of the first short-range telemetry sub and the at least one transmitting antenna of the second short-range telemetry sub each include a non-ferrite metallic substrate and a wire coil wrapped upon the non-ferrite metallic substrate.

31. The system of claim 17, wherein the at least one receiving antenna of the first short-range telemetry sub and the at least one receiving antenna of the second short-range telemetry sub includes a circumferential material comprising one or a combination of a metal, a non-metal, or a ferrite.

32. A method, comprising:
transmitting a signal via at least one transmitting antenna carried by a first short-range telemetry sub;
detecting, via at least one receiving antenna carried by a second short-range telemetry sub, the signal transmitted by the at least one transmitting antenna;
filtering the transmitted signal via a computing device to generate a filtered signal;
converting the filtered signal to a digital signal via the computing device; and
processing the digital signal via the computing device to reduce signal noise.

33. The method of claim 32, further comprising:
demodulating the digital signal via the computing device, and
transmitting the digital signal to a location uphole.

34. The method of claim 32, further comprising:
accessing communication information via the computing device;
identifying a communication setting based on the communication information via the computing device; and
instructing the at least one transmitting antenna to transmit signals and the at least one receiving antenna to receive signals in accordance with the communication setting via the computing device.

35. The method of claim 34, wherein the communication information includes a frequency band having a high signal strength region or a low noise energy region.

36. The method of claim 35, wherein the communication setting is the frequency band having the high signal strength region or the low noise energy region.

37. The method of claim 35, wherein the communication setting is a frequency band that does not correspond to the high noise energy region or the low signal strength region.

38. A short-range telemetry sub for a downhole tool assembly, the short-range telemetry sub comprising:
at least one antenna; and
a computing device configured to, in response to receiving a signal:
filter the received signal to generate a filtered signal;
convert the filtered signal to a digital signal; and
process the digital signal to reduce signal noise.

39. The short-range telemetry sub of claim 38, wherein the computing device is further configured to demodulate the digital signal, and transmit the digital signal to a location uphole.

40. The short-range telemetry sub of claim 38, wherein the computing device is further configured to:
access communication information detected by the at least one antenna,
identify a communication setting based on the communication information, and instruct at least one transmitting antenna to transmit signals in accordance with the communication setting.

41. The short-range telemetry sub of claim 40, wherein the communication information includes a frequency band having a high signal strength region or a low noise energy region.

42. The short-range telemetry sub of claim 40, wherein the communication setting is the frequency band having the high signal strength region or the low noise energy region.

43. The short-range telemetry sub of claim 41, wherein the communication setting is a frequency band that does not correspond to the high noise energy region or the low signal strength region.

44. The short-range telemetry sub of claim 38, further comprising at least one sensor configured to obtain drilling data indicative of one or more drilling parameters.

45. The short-range telemetry sub of claim 44, wherein the at least one sensor is one of an accelerometer, a magnetometer, or a strain gauge.

46. The short-range telemetry sub of claim 44, wherein the one or more drilling parameters includes tool inclination, tool face angle, azimuth, drill string rotational speed, temperature, pressure, mud motor speed, gamma radiation, or mud resistivity.

47. The short-range telemetry sub of claim 38, further comprising a sub body defining a first end, a second end spaced from the first end along a central axis, an outer surface, an inner surface, an internal passage that extends from the first end to the second end and is defined by the inner surface, a first hatch that carries the at least one antenna of the short-range telemetry sub, and a second hatch configured to contain the computing device.

48. The short-range telemetry sub of claim 38, wherein the computing device is further configured to switch the at least one antenna between a receiving antenna and a transmitting antenna.

49. The short-range telemetry sub of claim 38, further comprising a second antenna circumferentially wrapped around the surface of the sub.

50. The short-range telemetry sub of claim 49, wherein the at least one antenna is a receiving antenna and the second antenna is a transmitting antenna.
